(19) United States
(12) Patent Application Publication
(10) Pub. No.: US 2021/0341015 A1
(43) Pub. Date: Nov. 4, 2021

(54) GUIDE DEVICE AND GUIDE SYSTEM

(71) Applicant: Schock Metallwerk GmbH, Urbach (DE)

(72) Inventor: Joachim ZIMMERMANN, Schorndorf (DE)

(73) Assignee: Schock Metallwerk GmbH, Urbach (DE)

(21) Appl. No.: 17/378,061

(22) Filed: Jul. 16, 2021

Related U.S. Application Data
(63) Continuation of application No. PCT/EP2020/051798, filed on Jan. 24, 2020.

(30) Foreign Application Priority Data
Jan. 25, 2019 (DE) 10 2019 200 980.8

(51) Int. Cl. F16C 29/12; B60N 2/75

(52) U.S. Cl. CPC F16C 29/12; B60N 2/773

(57) ABSTRACT

In order to provide a guide device which is of simple construction and allows a stable and haptically pleasing sliding function, it is proposed that the guide device comprise the following: a first guide rail; a second guide rail; a bearing device by means of which the first guide rail and the second guide rail are mounted movably relative to each other; a coupling device that is different from the bearing device for influencing a movement of the guide rails relative to each other.

### RELATED APPLICATION

This application is a continuation of international application No. PCT/EP2020/051798 filed on Jan. 24, 2020, and claims the benefit of German application No. 10 2019 200 980.8 filed on Jan. 25, 2019, which are incorporated herein by reference in their entirety and for all purposes.

### FIELD OF DISCLOSURE

The present invention relates to a guide device which, for example, is employed in a guide system as a component of an arm rest device. In particular, use can be found for the guide device in a vehicle in the form of a component of a central arm rest in a motor vehicle for example. Furthermore, use thereof can be advantageous wherever a defined displacement force is desired and/or necessary.

### BACKGROUND

Guide devices in the form of drawer guides for example for enabling a drawer to be simply and easily pulled out from a corpus and then pushed back into it are known. In static applications, in particular, in the case of furniture, a particularly smooth-running implementation of the guide device is to be preferred. By contrast, in dynamic applications particularly in the case of usage in vehicles, an all too easily-running guide device can lead to an armrest of a central arm rest altering its position in an unwanted manner during braking processes or acceleration processes for example.

### SUMMARY OF THE INVENTION

Consequently, the object of the present invention is to provide a guide device which is of simple construction and allows a stable and haptically pleasing sliding function.

In accordance with the invention, this object is achieved by a guide device in accordance with claim 1.

The guide device preferably comprises a first guide rail and a second guide rail. In addition, there is preferably provided a bearing device for the guide device by means of which the first guide rail and the second guide rail are mounted such as to be movable relative to each other.

Furthermore, the guide device preferably comprises a coupling device for influencing a movement of the guide rails relative to each other.

The coupling device is, in particular, a device which differs from the bearing device, i.e. the coupling device on the one hand and the bearing device on the other hand are preferably formed by components of the guide device that differ from each other.

It may be expedient for the coupling device and the bearing device to be spatially separated from one another.

The bearing device preferably comprises one or more roller bodies, in particular, balls or cylinders.

A plurality of roller bodies are preferably accommodated and/or guided in a roller body cage.

A roller body cage is arranged, in particular, between the two guide rails.

The first guide rail and/or the second guide rail are preferably C-shaped in a cross section which is taken in particular perpendicularly to a direction of movement or a pulling direction.

The first guide rail and the second guide rail preferably each comprise a rail back which connects together two limbs of the respective guide rail that project transversely from the rail back. Each limb preferably comprises one or more roller body tracks on which the roller bodies roll for the purposes of supporting the guide rails relative to each other.

It may be advantageous for the guide device to comprise a device for impeding a relative movement of the two guide rails relative to each other. Such a device is in particular a brake mechanism.

It may be expedient for the coupling device to comprise a friction element which in particular is pressed or is pressable resiliently onto one of the guide rails and by means of which a friction effect is attainable for the purposes of braking the movement of the guide rails relative to each other.

In particular, the friction element is pressed against and/or abuts on one of the guide rails at least approximately permanently.

In particular, the friction element is pressed against one of the guide rails over at least approximately 50%, preferably over at least approximately 90% of a maximum relative path of movement of the guide rails relative to each other.

Preferably, the friction element is pressed against one of the guide rails over at least approximately the entire maximum relative path of movement of the guide rails relative to each other.

A braking action for braking the relative movement of the two guide rails relative to each other is preferably obtained by means of the friction element over at least approximately 50%, preferably over at least approximately 90% of a maximum relative path of movement of the guide rails relative to each other.

In particular, a braking action for braking the relative movement of the two guide rails relative to each other is obtained by means of the friction element over at least approximately the entire maximum relative path of movement of the guide rails relative to each other.

It may be expedient for the coupling device to comprise a locking element by means of which the guide rails are lockable relative to each other in at least one position. In particular, a locking action can be provided in one or two end positions at two mutually opposite ends of a maximum relative path of movement of the two guide rails relative to each other.

As an alternative or in addition thereto, a locking action can be provided in one or more intermediate positions, wherein in particular, the intermediate positions lie between the two end positions.

The coupling element and in particular the contact member, the locking element for example, preferably comprises a plurality of projections and/or recesses which are arranged in different positions in a direction running in parallel with a pressing direction and/or which end in different positions along a pressing direction in a direction running parallel to a pressing direction.

In particular, the pressing direction is that direction in which the coupling element and in particular the locking element acts on, for example is pushed onto or pressed against, a counter-piece, in particular a rail back, which interacts with the coupling element for the purposes of locking the arrangement.

Due to the use of projections and/or recesses which are arranged in different positions along a pressing direction, differing locking forces and in particular differing latching forces can preferably be obtained at different latching positions and in particular at one or more intermediate positions and/or at one or both end positions.

As an alternative or in addition thereto and in particular with the same objective, provision may be made for a counter-piece, in particular the rail back which interacts with the coupling element, in particular the contact member, the locking element for example, to comprise a plurality of projections and/or recesses which are arranged in different positions in a direction running in parallel with a pressing direction and/or which end in different positions along a pressing direction in a direction running parallel to a pressing direction.

Furthermore, as an alternative or in addition thereto, provision may be made for a counter-piece, in particular the rail back which interacts with the coupling element to comprise a plurality of sections which are arranged in different positions in a direction running parallel to a pressing direction. The coupling element preferably engages one or more and in particular all of these sections. In particular thereby, varying frictional forces can be obtained over a displacement path.

In particular, the counter-piece interacts with the contact member, with the friction element for example.

For example, one section of the counter-piece and in particular the rail back is a level region extending substantially parallel to the direction of movement which, for example, extends over at least approximately 2%, in particular, over at least approximately 10% and preferably over at least approximately 25% of the overall length of a path of movement and/or contact path of the coupling element. Preferably, one or more such sections are provided.

As an alternative or in addition thereto, provision may be made for one section of the counter-piece, in particular the rail back with which the coupling element preferably engages, to run at an angle relative to the direction of movement and/or at an angle relative to the pressing direction. Such a region extends in particular over at least approximately 2%, for example, over at least approximately 10% and preferably over at least approximately 25% of the overall length of a path of movement and/or contact path of the coupling element. Preferably, one or more such sections are provided.

As an alternative or in addition thereto, provision may be made for the counter-piece to comprise a plurality sections which differ from each other materially and/or in regard to the shape or surface texture thereof.

In particular, there are provided a plurality sections which exhibit mutually different coefficients of friction so that in the event of contact with the contact member different static friction forces and/or sliding friction forces then ensue.

For example, there are provided two or more sections with surfaces interacting with the coupling element which have coefficients of friction that differ from each other.

Different coefficients of friction can be obtained for example by different methods of production, treatment and/or post-processing of the counter-piece, in particular, of the surfaces of the counter-piece that interact with the contact member. For example, different coatings, embossments and/or degrees of polishing can be provided.

For example, a local variation of the coefficient of friction can be obtained in particular by local embossment of a surface texture, in particular a herringbone texture in order to finally create two or more sections exhibiting mutually different coefficients of friction.

Hereby for example, two or more than two of these sections can be arranged in different positions parallel to the pressing direction.

Furthermore as an alternative or in addition thereto, one or more and in particular all of these sections which exhibit mutually different coefficients of friction can be arranged in a common plane.

In particular thereby, the plane is oriented perpendicularly to the pressing direction.

The locking element is preferably a friction element and/or a latching element at the same time.

Furthermore, provision may be made for the coupling device to comprise a contact member which forms or comprises both the friction element and the locking element.

The coupling device preferably comprises a coupling element which is fixed to one of the guide rails, in particular, to a rail back of one of the guide rails.

It may be expedient for the coupling element to be fixed to a rail back of a guide rail, wherein the rail back connects two roller body tracks of the guide rail to one another.

The coupling element preferably projects in the direction of the further guide rail, in particular, in the direction of a rail back of the further guide rail.

The two guide rails are preferably substantially C-shaped and are arranged to be open facing each other.

It may be advantageous for the coupling element to be arranged entirely or at least partially between the two guide rails.

Furthermore, provision may be made for the coupling element to traverse a gap between the two guide rails.

In one configuration of the invention, provision may be made for the coupling element to comprise a fixing section for the fixing thereof to a guide rail, for the coupling element to comprise a seating section for accommodating and/or locating a contact member, in particular a friction element and/or a locking element, and for the coupling element to comprise a connecting section which is arranged between the fixing section and the seating section.

It may be expedient for

a) the fixing section and the connecting section; and/or

b) the fixing section and the seating section; and/or

c) the connecting section and the fixing section

to run along intersecting planes, wherein the planes in each case include an angle with one another and/or with the direction of movement or a pulling direction of less than 20° and in particular of less than 15°.

The fixing section extends to a greater extent in at least one or in at least two directions running perpendicular to a thickness direction of the coupling element than the connecting section and/or the seating section of the coupling element.

In particular thereby, a thickness direction is a direction in which a local material thickness is measured or would be measured.

In particular, the fixing section and/or the seating section are of greater dimension than the connecting section in one or two directions perpendicular to the thickness direction of the coupling element and/or perpendicular to the direction of movement or a pulling direction of the guide device and/or parallel to a plane in which a rail back of a guide rail runs.

Preferably, the fixing section and/or the seating section comprise one or more passage openings and/or cut-outs. In particular thereby, fixing elements and/or other components, for example, a contact member can be easily and reliably fixed to the coupling element, for example, by injecting and/or extruding in an injection moulding process.

The coupling element preferably extends at an angle through a gap of the guide device that is formed between the two guide rails, in particular, at an angle of less than 30° and in particular of less than 20° to the direction of movement or the pulling direction of the guide device.

Preferably, the coupling element extends over at least approximately 20%, preferably over at least approximately 30%, for example over approximately 40% of the overall length of a guide rail and/or the length of a maximum relative path of movement of the guide rails relative to each other.

It may be expedient for a centre point of the fixing section of the coupling element on the one hand and a centre point of the seating section and/or of the contact member on the other hand to be arranged such as to be mutually displaced along the direction of movement by in particular at least approximately 20%, preferably by at least approximately 30%, for example by approximately 40% of the overall length of a guide rail and/or of the length of a maximum relative path of movement of the guide rails relative to each other.

Preferably, a contact member, in particular a friction element and/or a locking element is pressable onto one of the guide rails by means of the coupling element which in particular is or comprises a product of plastics material or a bent sheet-metal product and/or a stamped product.

In particular, the coupling element forms or comprises a spring part of the coupling device for pressing a contact member of the coupling device onto one of the guide rails, in particular onto a rail back of one of the guide rails.

The coupling element can be formed in one-piece or be of multipart form.

For example, the coupling element is a spring part of the coupling device.

Furthermore, provision may be made for the coupling element to comprise a spring part and a contact member, wherein the contact member is resiliently fixed to one of the guide rails by means of the spring part and is pressable onto the other one of the guide rails.

A fixing section, a connecting section and/or a seating section of the coupling element are then in particular a fixing section, a connecting section and/or a seating section of the spring part.

It may be expedient for the spring part to be a sheet-metal component, in particular a stamped and/or bent component.

The contact member is preferably a plastics material component, in particular an injection moulded component of plastics material.

Preferably, the contact member is moulded, clipped onto the spring part and/or is latched thereto.

Furthermore, provision may be made for the contact member and the spring part to be formed from the same material, in particular formed in one piece manner of plastics material or metal and manufactured in an injection moulding process or a casting process or a shaping process.

The contact member preferably comprises at least one locking projection and/or at least one locking recess by means of which the contact member is latchable to the further one of the guide rails by at least one locking recess and/or at least one locking projection.

Furthermore, the contact member preferably comprises one or more frictional surfaces which are formed in particular by friction rails or friction bars of the contact member.

The frictional surfaces extend in particular to both sides of a locking projection and/or a locking recess of the contact member.

It may be expedient for the contact member to comprise one or more locking projections and/or one or more locking recesses, wherein a latching surface by means of which the contact member is able to be brought into engagement with the further guide rail for latching purposes or for some other arresting purpose is preferably displaced with respect to one or more frictional surfaces of the contact member, in particular, taken with respect to a pressing direction which is perpendicular to a rail back surface of the further guide rail on which the contact member abuts or is placeable.

Preferably, a latching surface of the contact member comes into engagement exclusively with a latching surface of the further guide rail corresponding thereto.

It may be expedient for the contact projection of the contact member to be substantially bell-shaped or semicircular in longitudinal section.

One or more frictional surfaces are preferably curved in one or more directions. Preferably, an optimized frictional effect can thereby be obtained and/or unwanted jamming or blocking of the contact member can be prevented.

It may be expedient for the at least one frictional surface and/or one guide rail, in particular a rail back of the guide rail on which the contact element abuts or is placeable to be provided with a lubricant. In particular, such a lubricant can contribute to a process of evening out the frictional effect and/or minimizing the static friction. Alternatively, increased sliding friction can be obtained by selection of a viscous lubricant for example.

Due to the curved construction of the frictional surfaces, it can preferably be ensured or at least optimized when using a lubricant that the lubricant always enters between the at least one frictional surface and the guide rail and is not scraped off or otherwise removed from the guide rail in the course of the movement of the guide rails relative to each other.

In particular, the lubricant is a synthetic or mineral oil or fat.

Preferably the lubricant comprises or is formed from a cold- and/or heat-resistant material, where a solidifying point of the lubricant is preferably below −20° C. and in particular under −40° C., and/or wherein a boiling point of the lubricant preferably lies over +80° C. and in particular over +120° C.

A locking projection of the contact member is preferably arranged between two frictional surfaces, in particular, between two friction rails or friction bars of the contact member.

It may be expedient for at least one locking projection of the contact member which is in the form of a locking bar for example, to extend substantially perpendicularly to one or more friction rails of the contact member.

In one configuration of the invention, provision may be made for the coupling device to comprise a coupling element which comprises a spring part, and for the spring part to be clamped between the two guide rails with bias in an installed state of the guide device.

A permanent contact pressure of a contact member on one of the guide rails is thus preferably exerted by means of the coupling element.

It may be expedient for the coupling device to comprise a coupling element which comprises a spring part, the bias and/or spring travel and/or spring force of which is adjustable or producible by means of an adjusting element of the coupling device.

When use is made of an adjusting element, provision may preferably be made for the coupling element to be arranged between the two guide rails free of bias without the adjusting element and for only the adjusting element to produce a pressing effect for pressing the contact member onto a guide rail.

In particular, provision may be made for the rail back of the guide rail to which a fixing section of the coupling element is fixed to comprise an adjusting element seating for accommodating an adjusting element.

The adjusting element seating is in the form of a passage opening provided with an internal thread for example. The adjusting element is then preferably a screw, for example a set-screw, which is arrangeable in different positions in the adjusting element seating. In particular, the extent to which the adjusting element projects through the passage opening into a gap of the guide device formed between the guide rails and to what degree the adjusting element acts on the coupling element can be adjusted by screwing the adjusting element in by different amounts.

In particular, an effect can be had on a connecting section of the coupling element by means of the adjusting element in order to produce, to adjust and/or to vary and in particular to strengthen the spring force of the coupling element and thus the friction effect of a friction element and/or the locking effect of a locking element.

Provision may be made for a rail back of a guide rail to comprise an adjusting element seating and for the adjusting element to be arrangeable and in particular fixable at different depths in the adjusting element seating for the purposes of adjusting the bias and/or the spring travel and/or the spring force of the spring part.

In particular, the adjusting element seating is a passage opening provided with an internal thread in a rail back of the guide rail, in particular in that rail back to which the coupling element is fixed by means of the fixing section.

For example, the adjusting element seating is constituted by a collar that is formed in the rail back or comprises such a thing, wherein in particular, a longer thread path of the adjusting element seating can be obtained in comparison with the other material thickness of the rail back.

It may be expedient for the adjusting element to be fixed in the adjusting element seating by means of a locking varnish and/or a lock nut, in particular, in accord with how a spring action of the spring part such as a spring travel and/or a spring force for example and/or a pressing effect for compressing the contact member had been adjusted by means of the adjusting element.

The guide device is suitable in particular for use in a guide system.

Such a guide system comprises in particular one, two or more than two guide devices, in particular, guide devices according to the invention for the movable connection of two components.

In particular, a movable armrest of a central arm rest can be realized by means of a guide system.

Consequently, the guide system is suitable in particular for use in a vehicle as a component of a central arm rest for example.

Thereby, the guide devices of a guide system are preferably oriented parallel to each other. In particular, the guide devices exhibit mutually parallel directions of movement or pulling directions.

Further preferred features and/or advantages of the invention form the subject matter of the following description and the pictorial illustration of exemplary embodiments.

### BRIEF DESCRIPTION OF THE DRAWINGS

FIG. 1 shows a schematic perspective illustration of a guide system which is employed as a component of an arm rest device for example and comprises two guide devices;

FIG. 2 a schematic perspective illustration of a guide device;

FIG. 3 a schematic longitudinal section through a guide device which comprises a coupling device for influencing a movement of two guide rails relative to each other;

FIG. 4 a schematic perspective illustration of a coupling element of the coupling device depicted in FIG. 3;

FIG. 5 a schematic plan view of the coupling element depicted in FIG. 4 as viewed along a direction of movement or pulling direction of the guide device;

FIG. 6 a schematic plan view of a wide side of the coupling element depicted in FIG. 4;

FIG. 7 a schematic longitudinal section through the coupling element depicted in FIG. 4;

FIG. 8 an enlarged illustration of the region VIII in FIG. 7;

FIG. 9 a schematic illustration corresponding to FIG. 8 of an alternative embodiment of a contact member of the coupling element; and

FIG. 10 a schematic longitudinal section through an alternative embodiment of a coupling device in which sections of a counter-piece of the coupling device are arranged in different positions parallel to a pressing direction.

Similar or functionally equivalent elements are provided with the same reference symbols in all of the Figures.

### DETAILED DESCRIPTION OF THE DRAWINGS

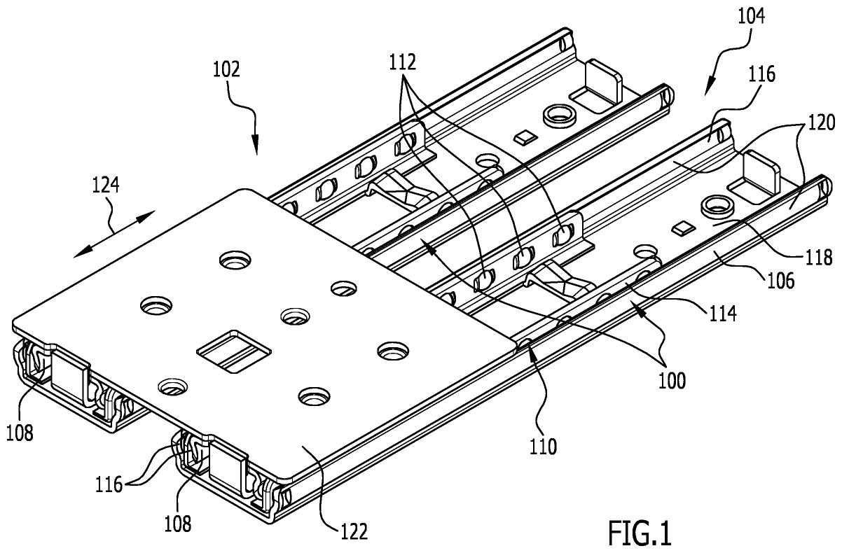

A guide device that is illustrated in FIG. 1 and referenced as a whole by 100 is for example a component of an arm rest device 102 on which a person can be supported. In particular, the arm rest device 102 is a component of a central arm rest of a motor vehicle. The guide device 100 is provided as a single or duplicated unit for example. In particular, there are provided two guide devices 100 which together form a guide system 104 of the arm rest device 102.

Hereby, the guide devices 100 are oriented such as to be parallel to each other.

In the case of the embodiment of the guide device 100 that is illustrated in FIG. 1, it comprises in particular a first guide rail 106 and a second guide rail 108, wherein the first guide rail 106 and the second guide rail 108 are movable relative to each other by means of a bearing device 110.

In particular, the bearing device 110 comprises a plurality of roller bodies 112 which are positioned relative to each other by means of a roller body cage 114 and roll on roller body tracks 116 of the guide rails 106, 108.

Each guide rail 106, 108 comprises a rail back 118 which connects two limbs 120 of each guide rail 106, 108 to one another.

In particular, the limbs 120 comprise the roller body tracks 116.

In the embodiment of the arm rest device 102 that is illustrated in FIG. 1, there is provided a cover plate 122 by means of which the two second guide rails 108 of the guide devices 100 are rigidly coupled to one another.

The two first guide rails 106 of the guide devices 100 are, for example, fixed to a (not illustrated) arm rest seating and are thereby rigidly connected to one another.

Consequently, the two guide devices 100 in the embodiment of the arm rest device 102 that is illustrated in FIG. 1 are operable exclusively together, in particular, are movable together back and forth between two end positions of the guide devices 100.

In particular thereby, the cover plate 122 is fixed to the rail back 118 of the second guide rails 108 of the guide devices 100.

As can be gathered from FIG. 1, the second guide rail 108 of each guide device 100 is shortened in comparison with the first guide rail 106.

In particular, the length of the second guide rail 108 along a direction of movement 124 of the guide device 100 corresponds at most to approximately 60%, for example to at most approximately 50% of the length of the first guide rail 106.

Preferably thereby, the bearing device 110 and in particular the roller bodies 112 as well as the roller body cage 114 are constructed, arranged and dimensioned in such a way that the second guide rail 108 is supported at least approximately uniformly on the first guide rail 106 by means of the roller bodies 112 over its entire length at all conceivable positions along the entire path of movement between two end positions. In particular, the second guide rail 108 does not project beyond the bearing device 110 and/or the first guide rail 106 along the direction of movement 124. A particularly stable configuration of the guide device 100 can thereby be obtained.

It can be expedient for the roller body cage 114 to be made longer than the second guide rail 108 in a direction running parallel to the movement of the second guide rail 108. In particular, the guide device 100 is then a linear guide.

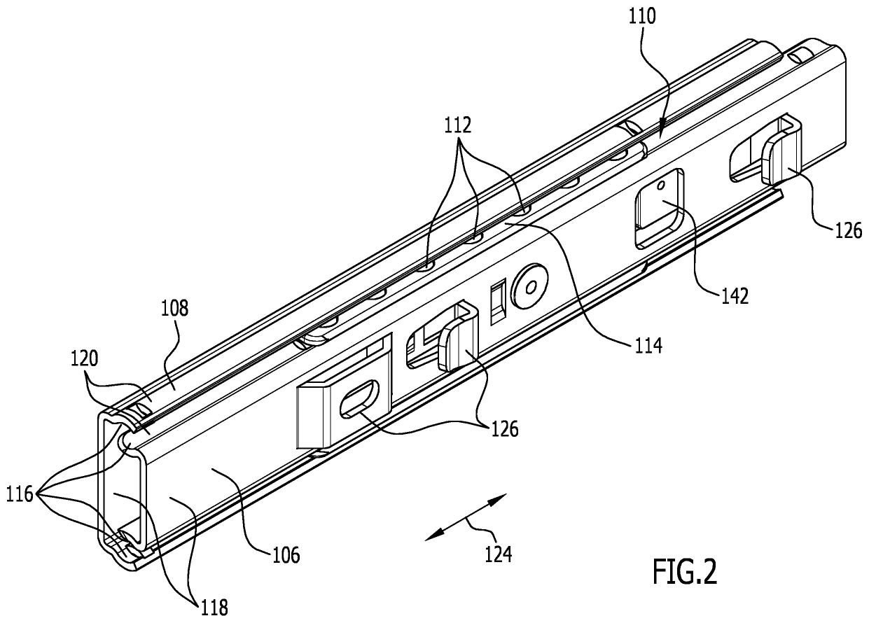

An alternative embodiment of a guide device 100 that is illustrated in FIG. 2 differs from the embodiment illustrated in FIG. 1 essentially in that the guide rails 106, 108 are of at least approximately the same length along the direction of movement 124.

Thus for example, the guide rails 106, 108 are arrangeable in an overlapping position in accordance with FIG. 2 or else in a (not illustrated) pulled out position in which the second guide rail 108 protrudes beyond the first guide rail 106 or else the first guide rail 106 protrudes beyond the second guide rail 108 along the direction of movement 124.

In addition, mounting elements 126 by means of which the guide device 100 is fixable are illustrated in FIG. 2.

In all other respects, the alternative embodiment of the guide device 100 that is illustrated in FIG. 2 corresponds in regard to the construction and functioning thereof with the embodiment illustrated in FIG. 1 so that to that extent reference should be made to the preceding description thereof.

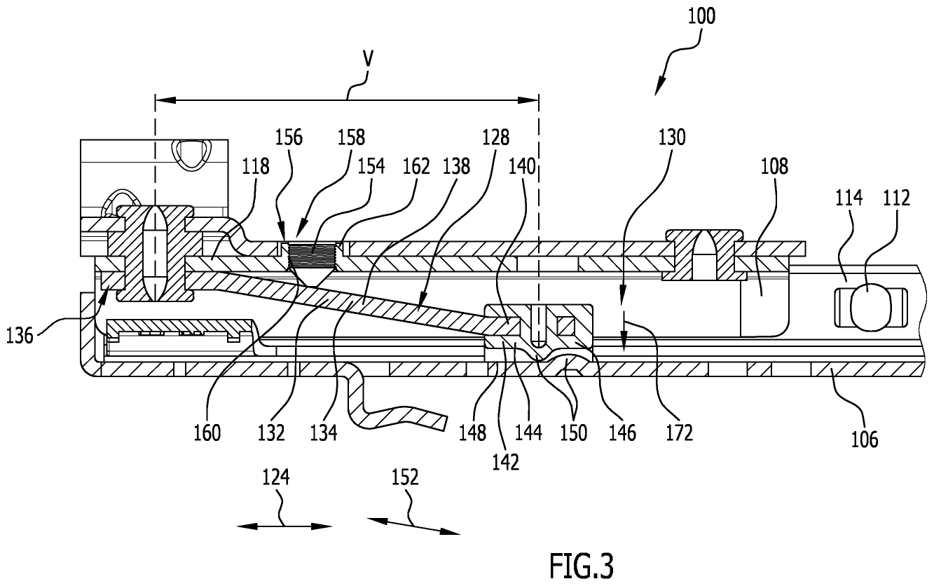

FIG. 3 shows a schematic longitudinal view through a guide device 100 which essentially corresponds to one of the guide devices 100 illustrated in FIG. 1, but the internal construction of which could also be provided for example by the guide device 100 illustrated in FIG. 2.

As can be gathered from FIG. 3, the guide device 100 preferably comprises a coupling device 128 which is arranged in particular in a gap 130 of the guide device 100 that is formed between the guide rails 106, 108.

The coupling device 128 comprises in particular a coupling element 132.

In particular, the coupling element 132 makes it possible to provide a mechanical coupling of the first guide rail 106 to the second guide rail 108, wherein this coupling is one that is different from the coupling obtained by the bearing device 110.

The coupling device 128 is in particular a device that is different from and/or is spatially separated from the bearing device 110.

The coupling element 132 preferably comprises a spring part 134 which comprises a fixing section 136, a connecting section 138 and a seating section 140. In particular, a positively-engaging connection and/or a substance-to-substance bond, for example a riveted joint and/or a welded joint, is provided for the purposes of fixing the fixing section 136 of the spring part 134 to a rail back 118 of one of the guide rails 106, 108.

The spring part 134 is fixed by means of the fixing section 136 to one of the guide rails 106, 108. In particular, the spring part 134 is fixed by means of the fixing section 136 to a rail back 118 of one of the guide rails 106, 108.

The seating section 140 of the spring part 134 serves for accommodating a contact member 142 which will be described in more detail in the following.

The connecting section 138 of the spring part 134 connects the fixing section 136 to the seating section 140.

The fixing section 136, the connecting section 138 and the seating section 140 of the spring part 134 are made from a metal sheet in particular by a stamping process and/or by bending or some other type of shaping or are in the form of a component of sheet metal and/or a plastics material. In particular, the spring part 134 is a metallic sheet-metal component. With regard to the geometrical details relevant for purposes of optimizing the mode of functioning of the spring part 134, this will be gone into in greater detail.

The contact member 142 forms in particular a friction element 144 and/or a locking element 146.

Consequently, a friction effect and a latching process or some other form of arresting function between the two guide rails 106, 108 can, in particular, be obtained by means of the spring part 134 and the contact member 142.

To this end in particular, the contact member 142 comprises one or more frictional surfaces 148 as well as one or more locking projections 150. As an alternative to one or more locking projections 150, (not illustrated) locking recesses could also be provided.

The spring part 134 and in particular the connecting section 138 of the spring part 134 preferably extends at an angle through the gap 130, for example, at an angle of less than 20°, preferably of less than 15° relative to the direction of movement 124.

In particular, a main direction of extent 152 of the connecting section 138 of the spring part 134 includes an angle with the direction of movement 124 of at most approximately 20°, for example of at most approximately 15°.

By suitable shaping of the coupling element 132 and in particular of the spring part 134, a predetermined pressing effect can preferably be obtained by means of which the contact member 142 is pressed onto one of the guide rails 106, 108, in particular onto a rail back 118 of one of the guide rails 106, 108.

For the production of and/or for more precise setting of this pressing effect, the guide device 100 preferably comprises an adjusting element 154 which is accommodated by means of an adjusting element seating 156 and in particular is fixable in different positions in the adjusting element seating 156.

The adjusting element seating 156 is, in particular, a passage opening 158 in a rail back 118 of one of the guide rails 106, 108.

In particular, the passage opening 158 is provided with an internal thread 160.

Preferably, the adjusting element seating 156 comprises a collar 162 that is fixed to the rail back 118 or is formed thereon or is formed out from the rail back 118, whereby the length of an internal thread 160 in the passage opening 158 can preferably be increased, in particular, compared with a length of an internal thread 160 if this were to only extend over the material thickness of the rail back 118.

As an alternative or in addition to a collar 162 formed out from the rail back 118 for example, a press-fit nut or some other auxiliary component could be provided in the rail back 118 for the purposes of producing an internal thread 160 in the passage opening 158.

In particular, the adjusting element 154 is in the form of a set-screw or some other type of screw element.

The adjusting element 154 is arrangeable and in particular fixable in the adjusting element seating 156 at different thread depths, and thereby projects by different amounts into the gap 130 between the guide rails 106, 108.

In particular, the adjusting element 154 projects into the gap 130 up to the coupling element 132 and thereby acts on the connecting section 138 of the spring part 134 for example.

Consequently, a spring force of the spring part 134 and/or a pressing effect of the contact member 142 can preferably be produced and/or set by means of the adjusting element 154.

As can be gathered from FIG. 3, the coupling element 132 does not extend on a direct path from one of the guide rails 106, 108 to the other. Rather, the coupling element 132 extends along the direction of movement 124 in such a way as to result in an offset V along the direction of movement 124 between a centre point of the fixing section 136 and a centre point of the contact member 142.

The offset V amounts in particular to at least approximately 20%, particularly to at least approximately 50% of a maximum path of movement of the guide rails 106, 108 relative to each other. Preferably thereby, a long lever effect of the coupling element 132 and/or an exact setting of the pressing effect can be obtained.

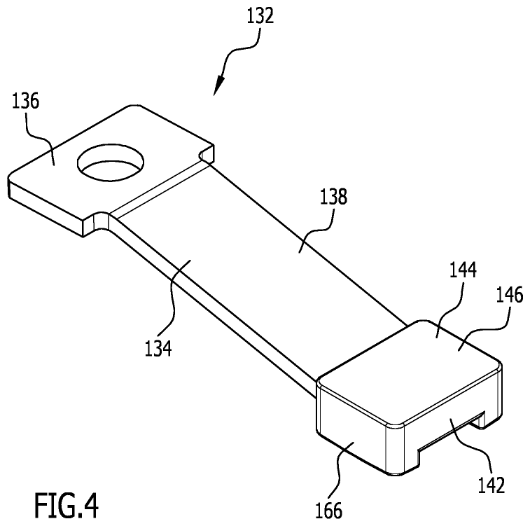

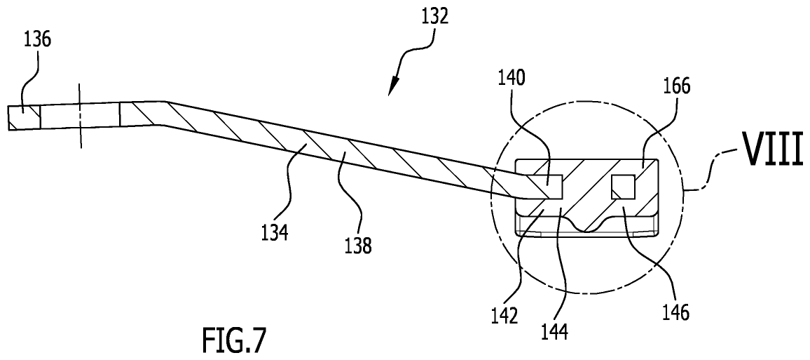

Further details of the coupling element 132 are illustrated in FIGS. 4 to 8.

In particular, the spring part 134 is manufactured in a stamping and/or bending process in the form of a metallic sheet-metal component. In particular, the contact member 142 is a component of plastics material of polyoxymethylene (POM) for example.

In particular, the contact member 142 is moulded onto the spring part 134 or is affixed thereto by a latching process.

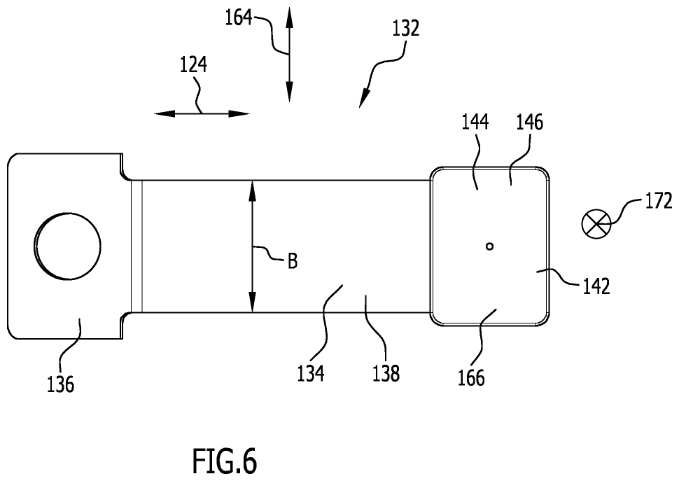

As can be gathered in particular from FIG. 6, the connecting section 138 of the spring part 134 is of smaller width B than the fixing section 136 of the spring part 134 in a transverse direction 164 running perpendicularly to the direction of movement 124. In particular, the width B of the connecting section 138 amounts to at most approximately 90%, preferably to at most approximately 85% of the width B of the fixing section 136.

The contact member 142 preferably projects beyond the connecting section 138 in the transverse direction 164. In particular, the contact member 142 preferably surrounds the seating section 140 on at least four sides, preferably on five sides.

In particular, the contact member 142 forms an end cap 166 for the spring part 134.

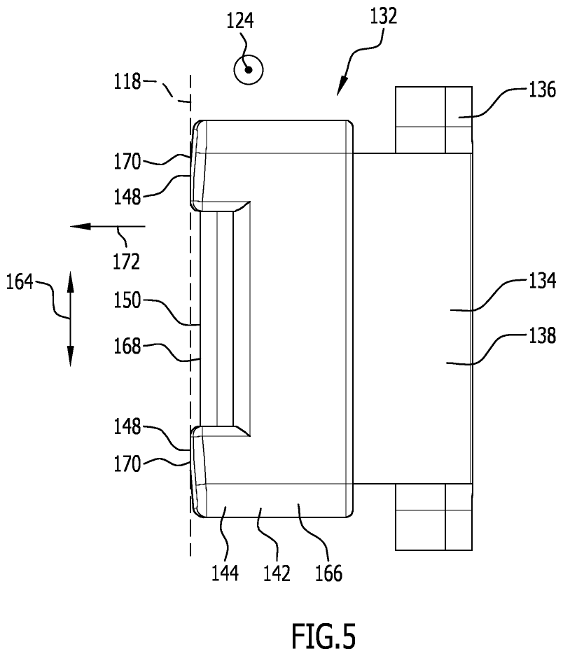

As is apparent in particular from FIG. 5, the contact member 142 comprises a latching surface 168 formed by the locking projection 150 in addition to two frictional surfaces 148.

In particular, the frictional surfaces 148 are formed by two friction rails 170 which extend along the direction of movement 124.

In particular thereby, the friction rails 170 extend substantially perpendicularly to the locking projection 150 which extends in particular in web-like manner between the friction rails 170.

The locking projection 150 is preferably arranged such as to be set back with respect to the friction rails 170 taken with reference to a pressing direction 172 running perpendicularly to a surface of the rail back 118 so that in particular the latching surface 168 is set back with respect to the frictional surfaces 148.

Consequently, upon the achievement of a friction effect on one of the guide rails 106, 108 by means of the frictional surfaces 148, the latching surface 168 does not come into contact with this guide rail 106, 108. Rather, the locking projection 150 and thus too the latching surface 168 formed thereby only comes into engagement, for example, with a further locking projection 150 which is formed on one of the guide rails 106, 108 in order to finally lock the guide rails 106, 108 relative to each other, for example, by a latching process.

Such a locking projection 150 of a guide rail 106, 108 is illustrated in particular in FIG. 3.

In particular thereby, the locking projection 150 is formed in such a way that the friction rails 170 forming the frictional surfaces 148 can be moved laterally past the locking projection 150 of the guide rail 106, 108 in the transverse direction 164 without coming into engagement with or making any other type of contact with the locking projection 150.

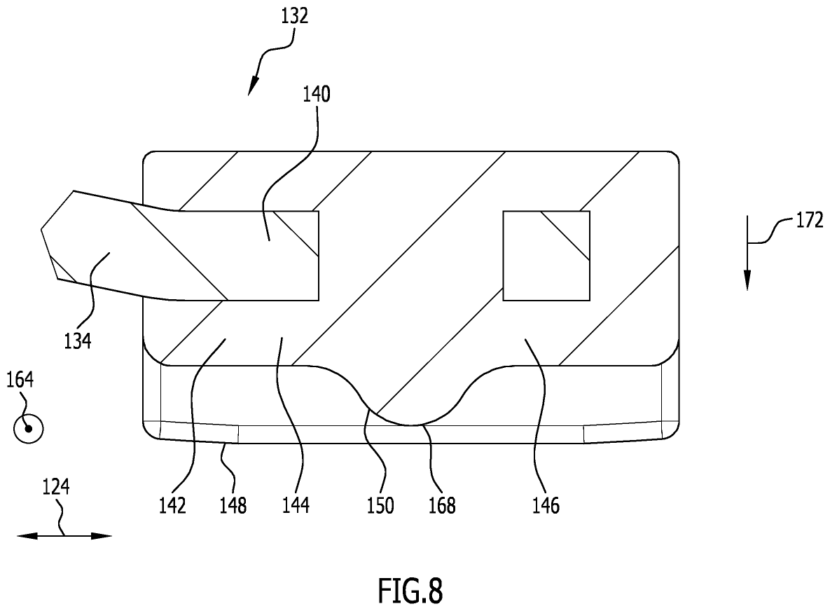

As can be gathered in particular from FIG. 8, the locking projection 150 of the contact member 142 is in essence rounded off. In particular, successive, at least approximately identical radii are envisaged for the purposes of constructing the locking projection 150. For example, following after a concave radius there is a convex radius and then once again a concave radius in order to form the locking projection 150.

The frictional surfaces 148 can for example be formed parallel to the surface of a rail back 118 of one of the guide rails 106, 108.

However it can be advantageous if the frictional surfaces 148 are formed such as to be curved along the direction of movement 124 and/or along the transverse direction 164. Preferably thereby, an optimized friction effect can be obtained and/or unwanted tilting of the contact member 142 can be prevented. Furthermore, unwanted scraping away or any other form of stripping away a lubricant can preferably be avoided or reduced thereby.

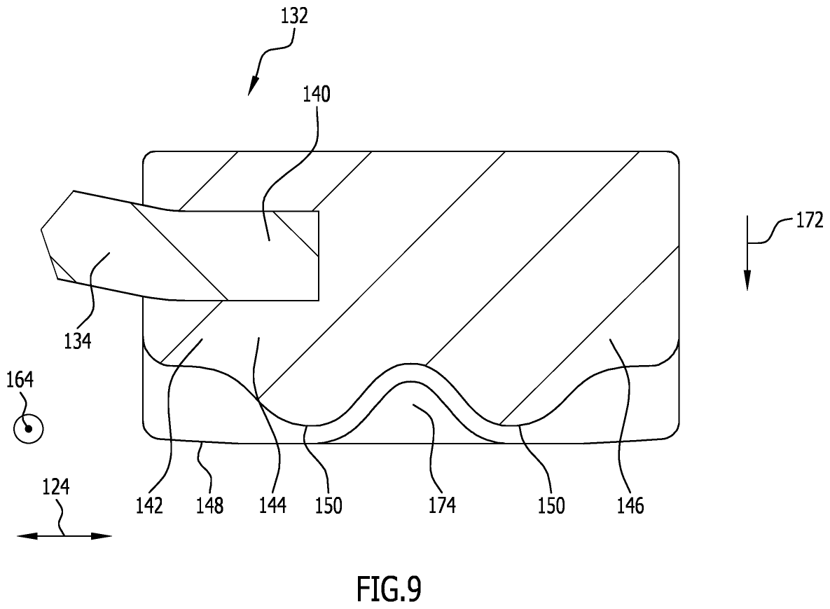

An alternative embodiment of the contact member 142 of the coupling element 132 that is illustrated in FIG. 9 differs from the embodiment illustrated in FIG. 8 essentially in that, for the purposes of the locking process, there are provided two locking projections 150 which in particular can accommodate between them a locking projection 150 on a counter-piece 174 on the rail back 118 for example. In particular thereby, an intermediate latching or a mid-latching process between two end positions of the guide rails 106, 108 relative to each other can be simply realized.

The locking projections 150 of the contact member 142 may, for example, be of identical heights in order to obtain identical unlatching forces in both directions of movement parallel or anti-parallel to a pulling direction (parallel to the path of movement).

As an alternative thereto however, provision may also be made for the locking projections 150 of the contact member 142 to be of different dimensions, in particular, to be of different heights along the pressing direction 174. In particular thereby, differing unlatching forces can be obtained for the purposes of unlatching in different directions.

In all other respects the alternative embodiment of the contact member 142 illustrated in FIG. 9 corresponds as regards construction and function with the embodiment illustrated in FIG. 8, so that to that extent reference should be made to the preceding description thereof.

Due to the fact that the guide device 100 comprises a coupling device 128 which comprises a coupling element 132 with a contact member 142, there is preferably obtained a convenient and haptically pleasing operation of the guide device 100 and thus too of the arm rest device 102. In addition for example, unwanted automatic shifting of an arm rest of the arm rest device 102 when driving a vehicle can be prevented by the use of contact member 142 forming a friction element 144.

In addition, due to the use of the spring part 134 described and/or the additional adjusting element 154, a particularly uniform and/or stable long-term frictional effect and/or latching effect are ensured.

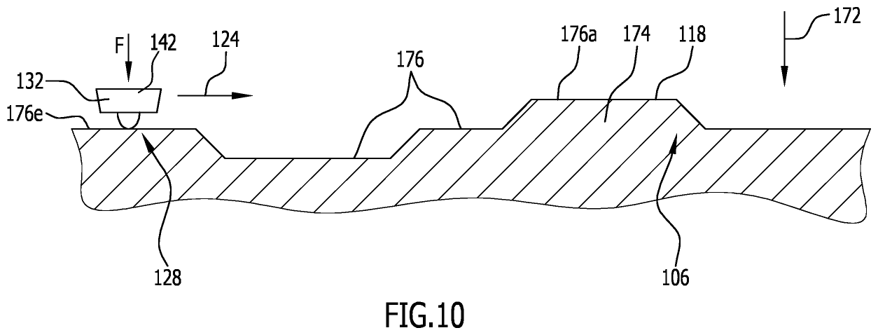

An alternative embodiment of a coupling device 128 that is illustrated in FIG. 10 differs from the previously described embodiments essentially in that the contact member 142 of the coupling element 132 interacts with a counter-piece 174 which comprises differently positioned sections 176 for example.

The counter-piece 174 is in particular a rail back 118 such as the rail back 118 of the first guide rail 106 for example. In particular, the counter-piece 174 is formed in the rail backs 118 or is formed by shaping the rail back 118.

However, provision may also be made for the counter-piece 174 to be an additional component which is arranged, in particular, on a rail back 118, for example, on the rail back 118 of the first guide rail 106.

The counter-piece 174 preferably comprises a plurality of sections 176 which each extend along a path of movement of the second guide rail 108 for example and/or parallel thereto and/or along a contact path of the contact member 142 and/or parallel therewith.

Each section 176 preferably forms a plateau on which or along which or parallel to which the contact member is 142 displaceable.

Two or more than two sections 176 are arranged at mutually differing positions parallel to the pressing direction 172. In particular, the two or the more than two sections 176 are arranged at different height levels or depth levels.

The coupling device 132 thus acts on the relative movement of the guide rails 106, 108 in a locally different manner along the direction of movement 124 due, in particular, to a locally different deflection of the spring part 134 (not illustrated in FIG. 10).

Provision may be made for the contact member 142 to come into contact or be brought into contact with only one, only two or more than two sections 176, in particular, in the course of a movement of the guide rails 106, 108 relative to each other from one end position to another end position.

In particular, provision may be made for the contact member 142 not to come into contact with or not to be brought into contact with one or more sections 176, in particular, in the course of a movement of the guide rails 106, 108 relative to each other from one end position to another end position.

For example provision may be made for the contact member 142 to come into contact with or not to be brought into contact with only one section 176e which is arranged in an end region of a path of movement of the guide rails 106, 108. In particular thereby, a process of stopping the guide rails 106, 108 relative to each other by means of the friction between the contact member 142 and the aforementioned section 176 can be effected.

As an alternative or in addition thereto, there may be provided one or more locally extra high sections 176a which are each positioned further along the pressing direction 172 in the direction of the contact member 142 than two sections 176 that are arranged on each side of the respective locally extra high sections 176a. Hereby, an intermediate stoppage point or at least a region of increased resistance to movement can be obtained between two end positions of the guide rails 106, 108.

In all other respects, the alternative embodiment of the coupling device 132 that is illustrated in FIG. 10 corresponds in regard to construction and functioning as desired with each one of the previously described embodiments so that to that extent reference should be made to the previous description thereof.

As an alternative or in addition thereto, provision may be made in particular for the purposes of local variation of the effect of the coupling device 132 on the relative movement of the guide rails 106, 108 for the counter-piece 174 to comprise a plurality of sections 176 which differ from each other materially and/or in regard to their shape or surface texture.

In particular, there are provided a plurality sections 176 which exhibit mutually different coefficients of friction so that different static friction forces and/or sliding friction forces result in the event of contact with the contact member 142.

Hereby for example, two or more than two of these sections 176 can be arranged in different positions parallel to the pressing direction 172. Furthermore, as an alternative or in addition thereto, one or more and in particular all of these sections 176 which exhibit mutually differing coefficients of friction can be arranged in a common plane.

In particular thereby, the plane is oriented perpendicularly to the pressing direction 172.

### LIST OF REFERENCE SYMBOLS

100 guide device

102 arm rest device

104 guide system

106 first guide rail

108 second guide rail

110 bearing device

112 roller bodies

114 roller body cage

116 roller body track

118 rail backs

120 limbs

122 cover plate

124 direction of movement

126 mounting element

128 coupling device

130 gap

132 coupling element

134 spring part

136 fixing section

138 connecting section

140 seating section

142 contact member

144 friction element

146 locking element

148 frictional surface

150 locking projection

152 main direction of extent

154 adjusting element

156 adjusting element seating

158 passage opening

160 internal thread

162 collar

164 transverse direction

166 end cap

168 latching surface

170 friction rail

172 pressing direction

174 counter-piece

176 section

B width

V offset

1. Guide device, comprising:
a first guide rail;
a second guide rail;
a bearing device by means of which the first guide rail and the second guide rail are movably mounted relative to each other;
a coupling device which is different from the bearing device for influencing a movement of the guide rails relative to each other.

2. A guide device in accordance with claim 1, wherein the coupling device comprises a friction element which is pressed resiliently onto one of the guide rails and by means of which a friction effect is attainable for the purposes of braking the movement of the guide rails relative to each other.

3. A guide device in accordance with claim 1, wherein the coupling device comprises a locking element by means of which the guide rails are lockable relative to each other in at least one position.

4. A guide device in accordance with claim 1, wherein the coupling device comprises a coupling element which is fixed to one of the guide rails in particular to a rail back of one of the guide rails.

5. A guide device in accordance with claim 4, wherein
a) the coupling element is arranged entirely or at least partly between the two guide rails; and/or
b) the coupling element traverses a gap between the two guide rails.

6. A guide device in accordance with claim 4, wherein the coupling element comprises
a fixing section for the purposes of fixing it to a guide rail;
a seating section for accommodating and/or positioning a friction element and/or a locking element; and
a connecting section that is arranged between the fixing section and the seating section.

7. A guide device in accordance with claim 6, wherein
a) the fixing section and the connecting section; and/or
b) the fixing section and the seating section; and/or
c) the connecting section and the fixing section run along intersecting planes, wherein the planes each include an angle of less than 20° and in particular of less than 15° to one another.

8. A guide device in accordance with claim 6, wherein the fixing section is of greater extent in at least one or in at least two directions running perpendicularly to a thickness direction than the connecting section and/or the seating section.

9. A guide device in accordance with claim 4, wherein the coupling element is in multipart form and comprises a spring part as well as a contact member, wherein the contact member is fixed resiliently to one of the guide rails by means of the spring part and is pressable onto the other one of the guide rails.

10. A guide device in accordance with claim 9, wherein
a) the spring part and the contact member are in the form of a one-piece or multi-part component of plastics material or
b) the spring part is a metal component of sheet metal and/or in that the contact member is a component of plastics material.

11. A guide device in accordance with claim 1, wherein the coupling device comprises a coupling element which comprises a spring part,
a) wherein the spring is clamped with bias between the two guide rails in an installed state of the guide device and/or in a completely pushed-in state of the guide device; and/or
b) wherein a bias and/or a spring travel and/or a spring force of the spring part is adjustable by means of an adjusting element of the coupling device.

12. A guide device in accordance with claim 1, wherein a rail back of a guide rail comprises an adjusting element seating and wherein an adjusting element of the coupling device is arrangeable and in particular fixable in the adjusting element seating in different positions and in particular at different depths for producing a pressing effect of a contact member and/or for adjusting a bias and/or the spring travel and/or the spring force of a spring part.

13. A guide device in accordance with claim 12, wherein the adjusting element seating is or comprises a passage opening in a rail back of the guide rail that is provided with an internal thread and wherein the adjusting element is in the form of a screw element.

14. A guide device in accordance with claim 1, wherein the coupling device comprises a coupling element and a counter-piece which interacts with the coupling element, wherein the counter-piece comprises a plurality of sections which are arranged in different positions in a direction running parallel to a pressing direction.

15. A guide device in accordance with claim 1, wherein the coupling device comprises a coupling element and a counter-piece which interacts with the coupling element, wherein the counter-piece comprises a plurality of sections having surfaces which interact with the coupling element which have mutually differing coefficients of friction.

16. A guide system comprising one, two or more than two guide devices in accordance with claim 1 for movably connecting two components.
